(19) United States
(12) Patent Application Publication
(10) Pub. No.: US 2008/0083456 A1
(43) Pub. Date: Apr. 10, 2008

(54) Method and a device for supplying at least one process gas

(76) Inventors: Richard Schauperl, Leibnitz (AT); Juergen Rechberger, Graz (AT); Peter Prenninger, Graz (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/905,256

(22) Filed: Sep. 28, 2007

(30) Foreign Application Priority Data
Oct. 9, 2006 (AT) A 1679/2006

(51) Int. Cl. H01M 8/04

(52) U.S. Cl. 137/1; 137/896

(57) ABSTRACT

The invention relates to a device for supplying at least one process gas, with independently set temperature and mass flow, in an input line of a test bed for fuel cells or fuel cell components, such as reformer, catalytic converter, etc. At least two dynamically controlled gas injectors are provided for each process gas, which are connected to feeder lines for two partial streams each at defined but different temperature levels, and which open into the input line for the process gas.

### BACKGROUND OF THE INVENTION

The invention relates to a method and a device for supplying at least one process gas, for which temperature and mass flow may be set independently of each other, and which is fed to a test bed for testing a fuel cell or component of a fuel cell, such as a reformer, catalytic converter, etc.

In test stations for fuel cells the process gases have to be conditioned as regards their thermodynamic characteristics (i.e., pressure, temperature, volume flow, humidity) and in part also as regards their composition from constituent gases. This may for instance be done with the use of a mixing station for the gases and electrical heaters. State-of-the-art test stations use mass flow controllers for adjusting the mass flow, heat exchangers for temperature control, and vapor tanks with proportional valves or direct vaporizers with mass flow controllers for humidity control. Temperature adjustment is carried out by temperature measurement and controlled electrical heating. Such test stations can achieve mass flow adjustment within a as time range, temperature adjustment within a 10 s range and humidity adjustment within a is range. The gas streams for anode and cathode—for example, in the case of low-temperature fuel cells (PEMFC)—are preheated up to temperatures of 150° C., prior to being fed to the fuel cell components (e.g., reformer, stack or individual cell). Depending on the chemical or electro-chemical reaction in the fuel cell components, gas temperatures at the outlet port of the component may be higher or lower than the entry temperature. High-temperature fuel cells (e.g., MCFC or SOFC) require correspondingly higher process gas temperatures of up to 950° C.

### SUMMARY OF THE INVENTION

It is an object of the present invention to improve a device and a method for providing at least one process gas for which temperature and mass flow may be independently set, in such a way that the temperature and mass flow of the process gas can be changed very quickly. A further object of the invention is to achieve rapid changes in the humidity of the process gas independently of the parameters of temperature and mass flow.

The invention achieves these objects by proposing that the process gas be mixed from at least two partial gas streams, each at a defined but different temperature level, by means of fast dynamically controlled gas injectors.

A device implementing the method of the invention is characterized by providing at least two dynamically controlled gas injectors for each process gas, which are connected to the input lines for two partial streams of the process gas with defined but different temperature levels and which open into the input line for the process gas. The device proposed by the invention for a test bed will provide defined amounts of gas of diverse species at a defined temperature level for two gas paths (anode and cathode), for example. Changes in mass flow or temperature may be achieved very fast in a time range of less than 100 ms.

The invention provides that a first partial stream of process gas is supplied to the gas injectors at a temperature in the ambient temperature range, say 25° C., while a second partial stream is supplied at a constant, higher temperature, e.g., in the range between 100° C. and 950° C.

For the purpose of cold-start testing the first or another partial stream of the process gas may be supplied to the gas injectors at a constant, lower temperature in a range of down to −35° C.

By preferably using characteristic-map controlled gas injectors for the two partial streams a predetermined mix temperature of the process gas may be achieved, which lies in the range of the exit temperatures of the partial streams, i.e., about −35° C. to 950° C. (for high-temperature fuel cells) or −35° C. to 150° C. (for low-temperature fuel cells).

In a preferred variant of the invention liquid water or water vapour may be added to the process gas by means of at least one additional injector. Changes in temperature, mass flow or humidity of the process gas may be achieved very rapidly due the very short response times of the injectors (0 to 10 ms). This means that the injector opens with a characteristic time delay after the operating voltage has been applied. Response time or transient rise time t90 is that length of time which the injector takes to reach 90% of the final value when a measurement variable (mass flow, temperature and/or humidity) has been changed.

For testing of a fuel cell the invention provides an anode gas stream containing the fuel, preferably H₂, and a cathode gas stream containing an oxidizing agent, preferably air, with mass flow and temperature of both process gas streams being adjusted independently of each other.

The conditioned gas mixtures may be fed to the test object, for instance a PEM fuel cell, separately for anode and cathode. In the device according to the invention defined gas mixtures with predetermined temperature are supplied separately for the anode and the cathode path. Gas composition depends on the test to be performed and may be variably set by an automated system.

### BRIEF DESCRIPTION OF THE DRAWINGS

The invention will be further described below, with reference to the variants shown in the schematic drawings attached. There is shown in

FIG. 1 a variant of the device according to the invention for supplying two process gases (anode gas stream and cathode gas stream) for fast dynamic testing of a fuel cell; and in

FIGS. 2 and 3 variants of the device of FIG. 1.

### DETAILED DESCRIPTION OF THE PREFERRED EMBODIMENTS

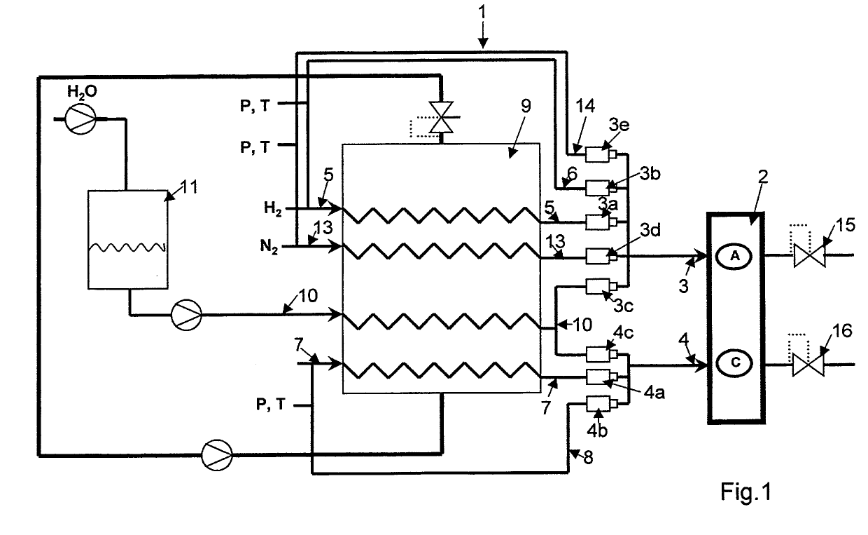

The device 1 shown in FIG. 1 supplying two process gases for a test bed (not shown in detail) for a fuel cell 2 (or a fuel cell stack) has an input line 3 for the anode gas stream and an input line 4 for the cathode gas stream. For each process gas two fast dynamically controllable gas injectors 3a, 3b and 4a, 4b are provided, which are connected to feeder lines 5, 6 and 7, 8 for two partial streams of process gases with defined but different temperature levels, and which open into the input lines 3 and 4 for the process gas.

The feeder lines 5, 7 for a partial stream of the process gas are passed through a heating unit 9 with constant high temperature in the range of up to 150° C., preferably an oil-bath heat exchanger. The other two feeder lines 6 and 8 each supply a partial stream of process gas at ambient temperature (approximately 25° C.). In a test bed for high-temperature fuel cells a heating unit 9 with a constant higher temperature of up to 950° C. is required.

The air path for the cathode may be furnished with a number of parallel-connected gas injectors of differing dimension thus providing an extended range of measurement.

Humidification of the process gases in the anode and cathode paths is carried out via an injector 3c or 4c, which also opens into the input line 3 or 4. Liquid water or water vapor is added to the process gas by means of these injectors. If liquid water is injected the vaporization heat required must be compensated by the hot carrier gas. The injectors 3c and 4c are connected to a water tank 11 via a line 10, with the line 10 passing through the heating unit 9, where the water is heated or evaporated prior to injection.

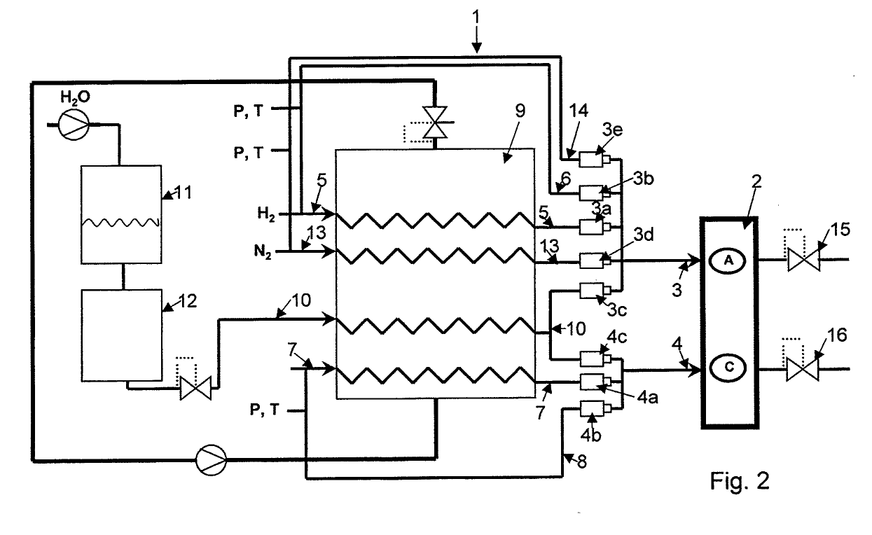

In the variant of FIG. 2 the liquid water is fed from the water tank 11 to an evaporator 12, and the water vapor in the line 10 passes through the heating unit 9, where it is heated prior to being fed into the injectors 3c and 4c.

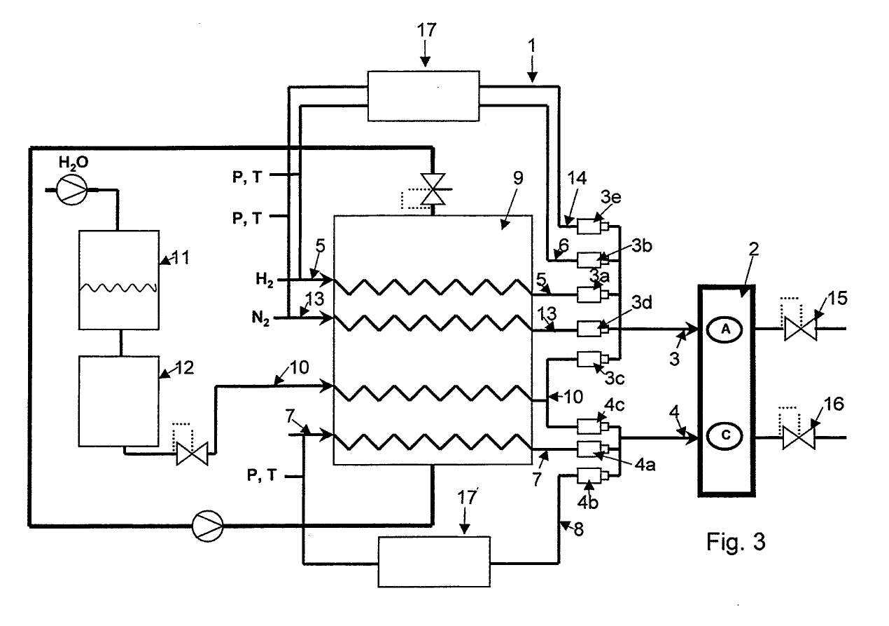

In the variant of FIG. 3 the feeder lines 6, 8 for a partial stream of the process gas are passed through a cooling unit 17 with constant temperature of down to −35° C., and thus cold-start tests of the fuel cell 2 can be carried out.

As shown in FIGS. 1 to 3 an inert gas, such as nitrogen, can be added to the process gas. The inert gas is preferentially supplied at two different levels of temperature. To this end two gas injectors 3d, 3e open into the input line 3 of the anode gas stream, with the input line 13 of the gas injector 3d passing through the heating unit 9 and the input line 14 of the gas injector 3e carrying inert gas at ambient temperature (FIG. 1 and FIG. 2). The inert gas is used to dilute the combustion gas in the anode gas stream. As shown in FIG. 3 the input line 14 of the gas injector 3e may also pass through the cooling unit 17, thus providing cooled inert gas.

On the exit side of the fuel cell to be tested controlled pressure keeping valves 15, 16 are shown, by means of which a predetermined, independent pressure may be set in the anode circuit and in the cathode circuit of the tested fuel cell.

In the examples shown, gas conditioning (temperature, mass flow and humidity) for each process gas is carried out by means of at least three gas injectors. The injectors are supplied with the respective process medium at a defined but different temperature level (e.g., −35° C., 25° C., 150° C., 950° C.). By controlling the three injectors via a characteristic map any mix temperature and humidification (in the range of 25° C. to 150° C. and 0 to 100% relative humidity) and any mass flow may be set. The gas injectors have response times between 0 and 10 ms permitting fast dynamic setting (less than 100 ms) of operating states.

What is claimed is:

1. A method for supplying at least one process gas, which is fed to a fuel cell or a fuel cell component in a fuel cell test bed for test purposes, wherein the process gas is mixed from at least two partial streams of the process gas with defined but differing temperature levels, by means of fast dynamically controlled gas injectors, to adjust temperature and mass flow of said process gas independently of each other

2. A method according to claim 1, wherein the gas injectors are supplied with a first partial stream of the process gas having ambient temperature, and with a second partial stream having constant higher temperature in the range between 100° C. and 950° C.

3. A method according to claim 2, wherein the first partial stream of the process gas has a temperature of about 25° C.

4. A method according to claim 1, wherein the first or another partial stream of the process gas supplied to the gas injectors has constant lower temperature in the range down to −35° C.

5. A method according to claim 1, wherein a predetermined mix temperature of the process gas within the range of the exit temperatures of the partial streams of the process gas of between −35° C. and 950° C. is set by means of characteristic-map controlled gas injectors.

6. A method according to claim 1, wherein liquid water or water vapour is added to the process gas by means of at least one further gas injector.

7. A method according to claim 1, wherein an inert gas such as nitrogen is added to the process gas.

8. A method according to claim 7, wherein the inert gas is supplied at least at two different temperature levels.

9. A method according to claim 1, wherein for the purpose of testing a fuel cell an anode gas stream containing the fuel and a cathode gas stream containing the oxidizing agent are supplied, where the mass flow and the temperature of the two process gas streams can be set independently of each other.

10. A device for supplying at least one process gas to the input line of a test bed for fuel cells or fuel cell components, wherein for each process gas at least two dynamically controllable gas injectors are provided, which are connected to feeder lines for the two partial streams of each process gas at defined but different temperature levels, and which open into the input line for the process gas to adjust the temperature and the mass flow of said process gas independently of each other.

11. A device according to claim 10, wherein said fuel cell component is a reformer or a catalytic converter.

12. A device according to claim 10, wherein at least one feed line for a partial stream of the process gas passes through a heater unit with constant higher temperature between 100° C. and 950° C.

13. A device according to claim 10, wherein at least one feed line for a partial stream of the process gas passes through a heater unit with constant higher temperature between 100° C. and 150° C.

14. A device according to claim 10, wherein at least one feed line for a partial stream of the process gas passes through a cooling unit with constant temperature in the range down to −35° C.

15. A device according to claim 10, wherein the device is provided with an input line for an anode gas stream, into which open two gas injectors for the fuel at differing temperature levels, and one injector for liquid water or water vapor, and furthermore with an input line for the cathode gas stream, into which open two gas injectors for an oxidizing agent, at different temperature levels and a further injector for liquid water or water vapor.

16. A device according to claim 15, wherein the fuel is H₂ and the oxidizing agent is air.

17. A device according to claim 15, wherein two gas injectors for an inert gas such as nitrogen supplied at different temperature levels, open into the input line for the anode gas stream.
